(19) United States
(12) Patent Application Publication
(10) Pub. No.: US 2018/0265817 A1
(43) Pub. Date: Sep. 20, 2018

(54) PROCESS FOR DRYING FABRICS

(71) Applicant: The Procter & Gamble Company, Cincinnati, OH (US)

(72) Inventors: Nea Janette LINTULA, Brussels (BE); Jean-Pol BOUTIQUE, Gembloux (BE); Johan SMETS, SMETS (BE); Karel Jozef Maria DEPOOT, Vichte (BE); Pascale Claire Annick VANSTEENWINCKEL, Weerde (BE)

(21) Appl. No.: 15/917,879

(22) Filed: Mar. 12, 2018

(30) Foreign Application Priority Data
Mar. 16, 2017 (EP) 17161267.4

(51) Int. Cl. C11D 3/50; C11D 17/00; F26B 3/00

(52) U.S. Cl. CPC C11D 3/505; D06F 58/02; F26B 3/00; C11D 17/0039

(57) ABSTRACT

The present invention discloses a process for drying wet fabrics.

### FIELD OF THE INVENTION

The present invention discloses a process for drying wet fabrics.

### BACKGROUND OF THE INVENTION

Drying of wet fabrics can be inefficient and time consuming. Sometimes it is difficult to find conditions that are suitable to ensure the fabrics dry quickly.

A convenient way of drying fabrics is via a tumble drying machine. Such machines are well known and have been used by consumers for a long time. However, an issue with use of tumble driers is that the high temperatures and humidity experienced during the drying process can be detrimental to encapsulated benefit agents, such as encapsulated perfumes, during the drying process. Often encapsulates prematurely rupture and/or benefit agents are decomposed/denatured.

Therefore, there is a need in the art for a convenient method for drying wet fabrics which minimises loss of encapsulated benefit agent.

It was surprisingly found that the process according to the present invention overcame the above technical problem.

### SUMMARY OF THE INVENTION

A first aspect of the present invention is a process for optimizing scent on fabrics following drying comprising the steps of;
a. Obtaining wet fabrics wherein the wet fabrics comprise a core/shell encapsulate deposited thereon;
b. Drying the fabrics in a tumble drying machine;
wherein the core/shell encapsulate comprises a core comprising a benefit agent and
wherein the shell comprises polyacrylate, polyurethane, polyurea or a mixture thereof.

A second aspect of the present invention is the use of a core/shell encapsulate wherein the core/shell encapsulate comprises a core comprising a benefit agent and wherein the shell comprises polyacrylate, polyurethane, polyurea or a mixture thereof as according to the present invention, to provide improved benefit agent deposition on fabrics following a tumble dry operation.

### DETAILED DESCRIPTION OF THE INVENTION

### Process

The present invention discloses a process for optimizing scent on fabrics following drying. The process comprises a step a. of obtaining wet fabrics wherein the wet fabrics comprise a core/shell encapsulate deposited thereon. The skilled person is aware of how to obtain wet fabrics with said encapsulate deposited thereon. Preferably, the wet fabrics are obtained from a laundry wash operation. Said laundry wash operation may be an automatic wash operation, semi-automatic wash operation, a hand wash operation or a mixture thereof.

The core/shell encapsulates may be deposited onto the wet fabrics prior to them being wetted, during wetting or after wetting. The core/shell encapsulate may be deposited onto the fabrics during a wash operation. The core/shell encapsulate may be comprised within a laundry detergent composition which is added to the wash operation. Alternatively, the core/shell encapsulate may be comprised within a pre-treatment composition which is used to treat a fabric ahead of the fabric being wetted.

The wet fabrics are obtained following a fabric laundry process, preferably wherein the fabrics have been laundered with a fabric detergent composition, a fabric softening composition or a mixture thereof. The fabric detergent composition may be in the form of a liquid, a powder, a water-soluble unit dose article or a mixture thereof.

During the fabric laundry process, the fabrics may be washed in a wash liquor wherein the wash liquor comprises the core/shell encapsulate.

The wash liquor may comprise further common laundry cleaning or softening ingredients, including but not limited to, surfactants, polymers, hueing dyes, brighteners, chelants, rheology modifiers, builders, bleaches, bleach activators, bleach boosters, aesthetic dyes, perfumes, enzymes and mixtures thereof.

The core/shell encapsulate is described in more detail below.

The process comprises a step b. of drying the fabrics in a tumble drying machine. Tumble drying machines are common and well known. Those skilled in the art will be aware of suitable tumble drying machines.

Preferably, the fabrics are dried at a temperature of between 50° C. and 90° C., more preferably between 55° C. and 90° C.

Preferably, the fabrics are dried in the tumble drying machine for between 5 mins and 120 mins, more preferably between 15 mins and 100 mins, most preferably between 20 mins and 90 mins.

### Core/Shell Encapsulate

A core/shell encapsulate is deposited onto the wet fabrics. Core/shell encapsulates comprise an outer shell defining an inner space in which a benefit agent is held until rupture of the shell.

The shell comprises polyacrylate.

Preferably the shell comprises from 50% to 100%, more preferably from 70% to 100%, most preferably from 80% to 100% of the polyacrylate. Preferably the polyacrylate comprises a polyacrylate cross linked polymer.

Preferably, the shell comprises a polymer derived from a material that comprises one or more multifunctional acrylate moieties; preferably said multifunctional acrylate moiety is selected from group consisting of tri-functional acrylate, tetra-functional acrylate, penta-functional acrylate, hexa-functional acrylate, hepta-functional acrylate and mixtures thereof; and optionally a polyacrylate that comprises a moiety selected from the group consisting of an amine acrylate moiety, methacrylate moiety, a carboxylic acid acrylate moiety, carboxylic acid methacrylate moiety and combinations thereof.

Preferably, the ratio of material that comprises one or more multifunctional acrylate moieties to material that comprises one or more methacrylate moieties is 999:1 to 6:4, more preferably from 99:1 to 8:1, most preferably from 99:1 to 8.5:1.

The core/shell encapsulate may comprise an emulsifier, wherein the emulsifier is preferably selected from anionic emulsifiers, nonionic emulsifiers, cationic emulsifiers or mixtures thereof, preferably anionic emulsifiers.

The core/shell encapsulate may comprise from 0.1% to 1.1% by weight of the core/shell encapsulate of polyvinyl alcohol. Preferably, the polyvinyl alcohol has at least one the following properties, or a mixture thereof:
(i) a hydrolysis degree from 55% to 99%;
(ii) a viscosity of from 40 mPa·s to 120 mPa·s in 4% water solution at 20° C.;
(iii) a degree of polymerization of from 1,500 to 2,500;
(iv) number average molecular weight of from 65,000 Da to 110,000 Da.

Preferably the core/shell encapsulate have a volume weighted mean particle size from 0.5 microns to 100 microns, preferably from 1 micron to 60 microns.

The core of the core/shell encapsulate may comprise greater than 10% by weight of the core of a partitioning modifier. Preferably, the portioning modifier comprises a material selected from the group consisting of propan-2-yl tetradecanoate, vegetable oil, modified vegetable oil and mixtures thereof. Preferably, said modified vegetable oil is esterified and/or brominated. Preferably said partitioning modifier comprises propan-2-yl tetradecanoate.

The liquid laundry detergent composition may comprise between 0.1% and 25%, preferably between 0.2% and 20%, more preferably between 0.5% and 10%, most preferably between 0.75% and 5% by weight of the liquid laundry detergent composition of the benefit agent.

The benefit agent may comprise a perfume, an enzyme or mixture thereof. Preferably the benefit agent comprises a perfume.

The benefit agent may comprise a perfume, preferably wherein the perfume comprises by weight of said perfume from 2.5% to 30%, preferably from 5% to 30% of perfume raw materials characterized by a log P lower than 3.0, and a boiling point lower than 250° C., from 5% to 30%, preferably from 7% to 25% of perfume raw material characterized by a log P lower than 3.0 and a boiling point higher than 250° C., from 35% to 60%, preferably from 40% to 55% of perfume raw materials characterized by a log P higher than 3.0 and a boiling point lower than 250° C., from 10% to 45%, preferably from 12% to 40% of perfume raw materials characterized by log P higher than 3.0 and a boiling point higher than 250° C.

### Test Method for Determining the Logarithm of the Octanol/Water Partition Coefficient (log P)

The value of the log of the Octanol/Water Partition Coefficient (log P) is computed for each PRM in the perfume mixture being tested. The log P of an individual PRM is calculated using the Consensus log P Computational Model, version 14.02 (Linux) available from Advanced Chemistry Development Inc. (ACD/Labs) (Toronto, Canada) to provide the unitless log P value. The ACD/Labs' Consensus log P Computational Model is part of the ACD/Labs model suite.

### Use

A further aspect of the present invention is the use of a core/shell encapsulate wherein the core/shell encapsulate comprises a core comprising a benefit agent and wherein the shell comprises polyacrylate, polyurethane, polyurea or a mixture thereof as according to the present invention, to provide improved benefit agent deposition on fabrics following a tumble dry operation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

### Examples

### The Following are Examples of Heavy Duty Liquid Laundry Detergent Compositions.

| | A | B | C | D | E | F | G |
|---|---|---|---|---|---|---|---|
| | (wt %) | (wt %) | (wt %) | (wt %) | (wt %) | (wt %) | (wt %) |
| AES C₁₂₋₁₅ alkyl ethoxy (1.8) sulfate | 11 | 10 | 4 | 6.32 | 0 | 0 | 0 |
| AE3S | 0 | 0 | 0 | 0 | 2.4 | 0 | 0 |
| Linear alkyl benzene sulfonate/sulfonic acid | 1.4 | 4 | 8 | 3.3 | 5 | 8 | 19 |
| HSAS | 3 | 5.1 | 3 | 0 | 0 | 0 | 0 |
| Sodium formate | 1.6 | 0.09 | 1.2 | 0.04 | 1.6 | 1.2 | 0.2 |
| Sodium hydroxide | 2.3 | 3.8 | 1.7 | 1.9 | 1.7 | 2.5 | 2.3 |
| Monoethanolamine | 1.4 | 1.49 | 1.0 | 0.7 | 0 | 0 | To pH 8.2 |
| Diethylene glycol | 5.5 | 0.0 | 4.1 | 0.0 | 0 | 0 | 0 |
| AE9 | 0.4 | 0.6 | 0.3 | 0.3 | 0 | 0 | 0 |
| AE8 | 0 | 0 | 0 | 0 | 0 | 0 | 20.0 |
| AE7 | 0 | 0 | 0 | 0 | 2.4 | 6 | 0 |
| Chelant (HEDP) | 0.15 | 0.15 | 0.11 | 0.07 | 0.5 | 0.11 | 0.8 |
| Citric Acid | 2.5 | 3.96 | 1.88 | 1.98 | 0.9 | 2.5 | 0.6 |
| C₁₂₋₁₄ dimethyl Amine Oxide | 0.3 | 0.73 | 0.23 | 0.37 | 0 | 0 | 0 |
| C₁₂₋₁₈ Fatty Acid | 0.8 | 1.9 | 0.6 | 0.99 | 1.2 | 0 | 15.0 |
| 4-formyl-phenylboronic acid | 0 | 0 | 0 | 0 | 0.05 | 0.02 | 0.01 |
| Borax | 1.43 | 1.5 | 1.1 | 0.75 | 0 | 1.07 | 0 |
| Ethanol | 1.54 | 1.77 | 1.15 | 0.89 | 0 | 3 | 7 |
| A compound having the following general structure: | 0.1 | 0 | 0 | 0 | 0 | 0 | 2.0 |
| bis((C₂H₅O)(C₂H₄O)n)(CH₃)—N⁺—CₓH₂ₓ—N⁺—(CH₃)- | | | | | | | |
| bis((C₂H₅O)(C₂H₄O)n), wherein n = from 20 to 30, and | | | | | | | |
| x = from 3 to 8, or sulphated or sulphonated variants thereof | | | | | | | |
| Ethoxylated (EO₁₅) tetraethylene pentamine | 0.3 | 0.33 | 0.23 | 0.17 | 0.0 | 0.0 | 0 |
| Ethoxylated Polyethylenimine | 0 | 0 | 0 | 0 | 0 | 0 | 0.8 |
| Ethoxylated hexamethylene diamine | 0.8 | 0.81 | 0.6 | 0.4 | 1 | 1 | |
| 1,2-Propanediol | 0.0 | 6.6 | 0.0 | 3.3 | 0.5 | 2 | 8.0 |
| Hydrogenated castor oil derivative structurant | 0.1 | 0 | 0 | 0 | 0 | 0 | 0.1 |
| Perfume | 1.6 | 1.1 | 1.0 | 0.8 | 0.9 | 1.5 | 1.6 |
| Protease (40.6 mg active/g) | 0.8 | 0.6 | 0.7 | 0.9 | 0.7 | 0.6 | 1.5 |
| Mannanase: Mannaway ® (25 mg active/g) | 0.07 | 0.05 | 0.045 | 0.06 | 0.04 | 0.045 | 0.1 |
| Amylase: Stainzyme ® (15 mg active/g) | 0.3 | 0 | 0.3 | 0.1 | 0 | 0.4 | 0.1 |
| Amylase: Natalase ® (29 mg active/g) | 0 | 0.2 | 0.1 | 0.15 | 0.07 | 0 | 0.1 |
| Xyloglucanase (Whitezyme ®, 20 mg active/g) | 0.2 | 0.1 | 0 | 0 | 0.05 | 0.05 | 0.2 |
| Lipex ® (18 mg active/g) | 0.4 | 0.2 | 0.3 | 0.1 | 0.2 | 0 | 0 |
| Neat Perfume ⁽¹⁾ | 0.5 | 0.5 | 0.5 | 0.5 | 0.5 | 0.5 | 0.5 |
| Perfume encapsulated in Polyacrylate capsules ⁽²⁾ | 0.25 | 3.2 | 2.5 | 4.0 | 2.5 | 1.4 | 0.8 |

| | |
|---|---|
| *Water, dyes & minors | Balance |

*Based on total cleaning and/or treatment composition weight, a total of no more than 12% water
⁽¹⁾ Optional.
⁽²⁾ Polyacrylate-based capsules encapsulating perfume.
Suitable perfume capsules can be purchased from Encapsys, (825 East Wisconsin Ave, Appleton, WI 54911), and are made as follows: a first oil phase, consisting of 37.5 g perfume, 0.2 g tert-butylamino ethyl methoacrylate, and 0.2 g beta hydroxyethyl acrylate is mixed for about 1 hour before the addition of 18 g CN975 (Sartomer, Exter, PA). The solution is allowed to mix until needed later in the process. A second oil phase consisting of 65 g of the perfume oil, 84 g isopropyl myristate, 1 g 2,2′-azobis(2-methylbutyronitrile), and 0.8 g 4,4′-azobis[4-cyanovaleric acid] is added to a jacketed steel reactor. The reactor is held at 35° C. and the oil solution in mixed at 500 rpm's with a 2″ flat blade mixer. A nitrogen blanket is applied to the reactor at a rate of 300 cc/min. The solution is heated to 70° C. in 45 minutes and held at 70° C. for 45 minutes, before cooling to 50° C. in 75 minutes. At 50° C., the first oil phase is added and the combined oils are mixed for another 10 minutes at 50° C. A water phase, containing 85 g Celvol 540 PVA (Sekisui Specialty Chemicals, Dallas, TX) at 5% solids, 268 g water, 1.2 g 4,4′-azobis[4-cyanovaleric acid], and 1.1 g 21.5% NaOH, is prepared and mixed until the 4,4′-AZOBIS[4-CYANOVALERIC ACID] dissolves. The water phase pH for this batch was 4.90. Once the oil phase temperature has decreased to 50° C., mixing is stopped and the water phase is added to the mixed oils. High shear agitation is applied to produce an emulsion with the desired size characteristics (1900 rpm's for 60 minutes.) The temperature was increased to 75° C. in 30 minutes, held at 75° C. for 4 hours, increased to 95° C. in 30 minutes, and held at 95° C. for 6 hours. The batch was allowed to cool to room temperature.

The following are examples of unit dose executions wherein the liquid composition is enclosed within a PVA film. The preferred film used in the present examples is Monosol M8630 76 μm thickness.

| | Comparative example | | | Invention example | | |
|---|---|---|---|---|---|---|
| | Compartment # | | | | | |
| | bottom | Top 1 | Top 2 | bottom | Top 1 | Top 2 |
| Dosage (g) | 25.7 | 1.71 | 1.71 | 25.7 | 1.71 | 1.71 |
| Ingredients (Wt %) | | | | | | |
| C₁₁₋₁₃ alkylbenzene | 19 | 17 | 16 | 19 | 17 | 16 |
| sulfonic acid | | | | | | |
| C₁₂₋₁₄ alkyl 7- | 8 | 6 | 6 | 8 | 6 | 6 |
| ethoxylate | | | | | | |
| C₁₄₋₁₅ alkyl 7- | 6 | 6 | 6 | 6 | 6 | 6 |
| ethoxylate | | | | | | |
| C₁₂₋₁₄ alkyl ethoxy 3 | 5 | 8 | 8 | 5 | 8 | 8 |
| sulfate | | | | | | |
| Citric acid | 0.7 | 0.6 | 0.6 | 0.7 | 0.6 | 0.6 |
| C₁₂₋₁₈ Fatty acid | 11 | 5 | 5 | 11 | 5 | 5 |
| Enzymes | 2 | — | — | 2 | — | — |
| Ethoxylated | 3 | 5 | 5 | 3 | 5 | 5 |
| Polyethylenimine¹ | | | | | | |
| Hydroxyethane | 0.8 | 0.7 | 0.7 | 0.8 | 0.7 | 0.7 |
| diphosphonic acid | | | | | | |
| Brightener | 0.3 | — | — | 0.3 | — | — |
| MgCl2 | 0.2 | 0.2 | 0.2 | 0.2 | 0.2 | 0.2 |
| Free Perfume | 2.1 | — | — | 2.1 | — | — |
| K₂SO₃ | 0.4 | — | — | 0.4 | — | — |
| Perfume | 0.40 | — | — | — | — | — |
| encapsulated in MF | | | | | | |
| capsules² | | | | | | |
| Perfume | — | — | — | 0.40 | — | — |
| encapsulated in | | | | | | |
| Polyacrylate | | | | | | |
| capsules³ | | | | | | |
| Minors (antioxidant, | 2.0 | 2.0 | 2.0 | 2.0 | 2.0 | 2.0 |
| aesthetics, | | | | | | |
| structurant, | | | | | | |
| opacifier, . . . ) | | | | | | |
| MonoEthanolamine | pH 8 | pH 8 | pH 8 | pH 8 | pH 8 | pH 8 |
| to | | | | | | |
| Water and solvents | 100% | 100% | 100% | 100% | 100% | 100% |
| (1,2 propanediol, | | | | | | |
| glycerol, ethanol) to | | | | | | |

¹Polyethylenimine (MW = 600) with 20 ethoxylate groups per —NH.
²Melamine Formaldehyde (MF) perfume capsule coated with a polyvinylformamide deposition aid.
Suitable perfume capsules can be purchased from Encapsys, (825 East Wisconsin Ave, Appleton, WI 54911), and are made as follows: 25 grams of butyl acrylate-acrylic acid copolymer emulsifier (Colloid C351, 25% solids, pka 4.5-4.7, (Kemira Chemicals, Inc. Kennesaw, Georgia U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, New Jersey, U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 85° C. and maintained overnight with continuous stirring to complete the encapsulation process. A volume-mean particle size of 18 microns is obtained. 14 milliliters of the aqueous suspension of perfume capsules obtained as per the above are placed in a 20 milliliter centrifuge tube. 6 identical tubes are prepared and placed in a batch centrifuge (IEC Centra CL2). After 20 minutes at 3800 RPM, the centrifuge tubes are removed, and three layers are observed: perfume capsule cake layer on top, followed by an aqueous layer, followed by a high density solid particulate layer. The top capsule layer is isolated from the remaining material, and reconstituted to make a phase stable suspension. To 20.8 grams of the top perfume capsule layer is added 10.6 grams of DI water, then 1.6 grams of urea (Potash Corporation), 6.0 grams of 1 wt % aqueous solution of Optixan Xanthan Gum (ADM Corporation), and 2.4 grams of 32 wt % magnesium chloride solution (Chemical Ventures). 0.5 grams of a cationic modified co polymer of poly vinylamine and N-vinyl formamide (BASF Corp) is added.
³Polyacrylate-based capsules encapsulating perfume.
Suitable perfume capsules can be purchased from Encapsys, (825 East Wisconsin Ave, Appleton, WI 54911), and are made as follows: a first oil phase, consisting of 37.5 g perfume, 0.2 g tert-butylamino ethyl methoacrylate, and 0.2 g beta hydroxyethyl acrylate is mixed for about 1 hour before the addition of 18 g CN975 (Sartomer, Exter, PA). The solution is allowed to mix until needed later in the process.
A second oil phase consisting of 65 g of the perfume oil, 84 g isopropyl myristate, 1 g 2,2′-azobis(2-methylbutyronitrile), and 0.8 g 4,4′-azobis[4-cyanovaleric acid] is added to a jacketed steel reactor. The reactor is held at 35° C. and the oil solution in mixed at 500 rpm's with a 2″ flat blade mixer. A nitrogen blanket is applied to the reactor at a rate of 300 cc/min. The solution is heated to 70° C. in 45 minutes and held at 70° C. for 45 minutes, before cooling to 50° C. in 75 minutes. At 50° C., the first oil phase is added and the combined oils are mixed for another 10 minutes at 50° C. A water phase, containing 85 g Celvol 540 PVA (Sekisui Specialty Chemicals, Dallas, TX) at 5% solids, 268 g water, 1.2 g 4,4′-azobis[4-cyanovaleric acid], and 1.1 g 21.5% NaOH, is prepared and mixed until the 4,4′-AZOBIS[4-CYANOVALERIC ACID] dissolves. The water phase pH for this batch was 4.90. Once the oil phase temperature has decreased to 50° C., mixing is stopped and the water phase is added to the mixed oils. High shear agitation is applied to produce an emulsion with the desired size characteristics (1900 rpm's for 60 minutes.) The temperature was increased to 75° C. in 30 minutes, held at 75° C. for 4 hours, increased to 95° C. in 30 minutes, and held at 95° C. for 6 hours. The batch was allowed to cool to room temperature.

### Data

### Wash Test

Products (Comparative Example and Invention Example) are used to run a full scale wash in Miele Softronic W1714 washing machine.

For the test 3 kg ballast load is used. The load consists of 600 g polyester, 600 g polycotton, 600 g muslin (flat) cotton, 600 g knitted cotton and 600 g terry towels.

Ballast loads are preconditioned in Miele Softronic W1714 washing machine by running a short cotton cycle wash at 95° C. In total 4 runs are done: 2 runs where 70 g unperfumed powder is added in the dispenser followed by 2 runs without detergent.

After preconditioning the ballast loads are tumble dried.

For each washtest 12 small terry tracers (100% cotton, 30×30 cm) are added into the washing machine. These tracers are preconditioned in same way as ballast load (50 terry tracers per washing machine).

Before running the test washing machines are boiled out using a cotton cycle run at 95° C.

After wash the ballast load and the terry tracers are dried in a tumble drying machine at 77° C. for 1 hour 15 mins.

Terry tracers dried in the tumble drying machine are submitted for olfactive evaluation to a panel of 2 perfumers. Tracers are evaluated on dry fabric odor pre-rub, after rubbing the fabric by using Primavera scale (intensity scale from 0-100) and average result are detailed below.

| | | Pre-Rub | Post-Rub |
|---|---|---|---|
| Fresh | Comparative Example | 20 | 25 |
| | Inventive Example | 22.5 | 32.5 |
| 2 weeks 50 C. | Comparative Example | 20 | 22.5 |
| | Inventive Example | 30 | 37.5 |

Inventive Example has higher freshness then comparative example, at equal level of the perfume capsules. Difference is especially large after ageing of the examples for 2 weeks at 50° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.
Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for optimizing scent on fabrics following drying comprising the steps of;
a. Obtaining wet fabrics wherein the wet fabrics comprise a core/shell encapsulate deposited thereon;
b. Drying the fabrics in a tumble drying machine;
wherein the core/shell encapsulate comprises a core comprising a benefit agent and
wherein the shell comprises polyacrylate, polyurethane, polyurea or a mixture thereof.

2. The process according to claim 1, wherein the fabrics are dried at a temperature of between about 50° C. and about 90° C.

3. The process according to claim 1 wherein the fabrics are dried in the tumble drying machine for between about 5 mins and about 120 mins.

4. The process according to claim 1 wherein the wet fabrics are obtained following a fabric laundry process, wherein the fabrics have been laundered with a fabric detergent composition, a fabric softening composition or a mixture thereof.

5. The process according to claim 4 wherein during the fabric laundry process, the fabrics are washed in a wash liquor wherein the wash liquor comprises the core/shell encapsulate.

6. The process according to claim 1 wherein the shell comprises from about 50% to about 100% of the polyacrylate.

7. The process according to claim 1 wherein the polyacrylate comprises a polyacrylate cross linked polymer, comprising a polymer derived from a material that comprises one or more multifunctional acrylate moieties; said multifunctional acrylate moiety is selected from group consisting of tri-functional acrylate, tetra-functional acrylate, penta-functional acrylate, hexa-functional acrylate, hepta-functional acrylate and mixtures thereof.

8. The process according to claim 7, wherein the polyacrylate comprises a moiety selected from the group consisting of an amine acrylate moiety, methacrylate moiety, a carboxylic acid acrylate moiety, carboxylic acid methacrylate moiety and combinations thereof.

9. The process according to claim 1 wherein the benefit agent comprises a perfume, an enzyme or mixture thereof.

10. The process according to claim 9, wherein the benefit agent comprises a perfume, wherein the perfume comprises by weight of the perfume from about 2.5% to about 30% of perfume raw materials characterized by a log P lower than about 3.0, and a boiling point lower than about 250° C.
